(19) United States
(12) Patent Application Publication
(10) Pub. No.: US 2021/0115233 A1
(43) Pub. Date: Apr. 22, 2021

(54) POWER CABLE

(71) Applicant: PRYSMIAN S.p.A., Milano (IT)

(72) Inventors: Alberto BAREGGI, Milano (IT); Luigi CAIMI, Milano (IT)

(73) Assignee: PRYSMIAN S.p.A., Milano (IT)

(21) Appl. No.: 16/464,429

(22) PCT Filed: Nov. 30, 2016
(86) PCT No.: PCT/IB2016/057199

§ 371 Date: May 28, 2019

(51) Int. Cl. C08L 23/12; H01B 3/44; C08L 23/06; C08L 23/08; C08L 23/14

(52) U.S. Cl. CPC C08L 23/12; H01B 3/441; H01B 9/00; C08L 23/0815; C08L 23/14; C08L 23/06

(57) ABSTRACT

Power cable having an insulation system comprising at least one layer made of a thermoplastic material based on a polypropylene matrix admixed with a dielectric fluid, the thermoplastic material having a melting enthalpy of from 15 to 50 J/g and the polypropylene matrix being made of a material selected from: a heterophasic ethylene-propylene copolymer (a) having a melting enthalpy of from 15 to 50 J/g; or an intimate admixture of (a) and a propylene homopolymer or an ethylene propylene copolymer (b) having a melting enthalpy greater than 50 J/g. The cable is particularly suitable for current transport at high voltage or extra high voltage.

### TECHNICAL FIELD

The present invention relates to the field of power cables. In particular, the present invention relates to a power cable especially suitable for carrying current at high voltage (HV) or extra high voltage (EHV) either in direct current (DC) or in alternating current (AC).

### BACKGROUND ART

An energy cable for transporting or distributing electric energy, in particular for medium, high and extra high voltage, typically comprises at least one cable core. Each cable core is usually formed by at least one conductor, made of a conductive metal, sequentially surrounded by an insulating system comprising an inner semiconductive layer, an insulating layer and an outer semiconductive layer. If the cable is for high or extra high voltage applications, the cable core is typically surrounded by a screen layer, which may be made of metal or metal and polymeric material. The screen layer may be in the form of wires (braids), of tapes helically wound around the cable core or of a metal sheet, optionally coated with a polymer, wrapped around the at least one cable core and having longitudinal rims overlapped one another and welded or glued.

The inner semiconductive layer, the insulating layer and the outer semiconductive layer are typically polymeric layers.

Such polymeric layers are typically made from a polyolefin-based crosslinked polymer, in particular crosslinked polyethylene (XLPE), or elastomeric ethylene/propylene (EPR) or ethylene/propylene/diene (EPDM) crosslinked copolymers, as disclosed e.g. in WO 98/52197. After extrusion and crosslinking, the cable—coiled on a reel or spool—must be subjected to a degassing step, during which the volatile chemicals produced by the crosslinking reaction and entrapped within the cable layers are released. The degassing period is typically long (up to 50 days or even more, depending on the thickness of the insulating system) and represents a stand-by period in the manufacturing process of the cable that increases the production time and cost. This manufacturing step is particularly critical for high voltage direct current (HVDC) cables, because the cross-linking by-product possibly remaining in the insulating layer may cause failure due to space charge accumulation.

As an alternative to crosslinked polymers, the insulating system of an energy cable, or part of it, may be made from thermoplastic materials, i.e. materials which are not crosslinked and that accordingly do not require a degassing step during the manufacturing process of the cable. In this respect, electric cables comprising at least one layer of the insulating system, in particular the insulating layer, based on a polypropylene matrix intimately admixed with a dielectric fluid (in the following also referred to as “thermoplastic cables”) are known and disclosed, e.g., in WO 02/03398, WO 02/27731, WO 04/066318, WO 07/048422 and WO 08/058572. The polypropylene matrix useful for this kind of cables comprises a polypropylene homopolymer or copolymer or both, characterized by a relative low crystallinity such to provide the cable with the suitable flexibility, while preserving the mechanical properties and thermopressure resistance at the cable operative and overload temperatures. Performance of the cable coating, especially of the insulating layer, is also affected by the presence of the dielectric fluid intimately admixed with the polypropylene matrix.

In particular, WO 02/03398 relates to a cable for transporting or distributing high voltage electric energy, wherein the thermoplastic material comprises a propylene homopolymer or a copolymer of propylene having a melting enthalpy of from 30 to 100 J/g, optionally in mechanical mixture with a low crystallinity polymer, generally with a melting enthalpy of less than 30 J/g. The dielectric strength test shows that a propylene homopolymer having a melting enthalpy of 56.7 J/g has a slightly better behavior than a heterophase propylene copolymer having a melting enthalpy of 32 J/g.

WO07/048422 relates to a cable for transporting or distributing high voltage electric energy, wherein the thermoplastic polymer material comprises at least 75% by weight of a propylene copolymer having a melting enthalpy lower than 25 J/g; and an amount equal to or less than 25% by weight of a propylene homopolymer or propylene copolymer having a melting enthalpy higher than 25 J/g; and the covering layer has a melting enthalpy equal to or lower than 40 J/g. The tests indicate that thermopressure resistance can decrease at the decreasing of melting enthalpy.

The growing demand for energy requires the implementation of cables designed to support increasingly higher voltage and power levels. Cable for extra high voltage (EHV) should be suitable for carrying current at voltage greater than 150 kV, up to 500 kV or more. In such applications the cable insulating layer is particularly challenged and is to be made of a clean material free from morphological defects for effectively bearing the electric stress.

To improve the electric performance of thermoplastic cables intended for HV power transport the inclusion of additives has been proposed. WO2013/017916 teaches the addition of a nucleating agent to an electrically insulating layer based on a thermoplastic polymer material intimately admixed with a dielectric fluid can remarkably reduce the risk of formation of such morphological defects.

### SUMMARY OF THE INVENTION

The Applicant performed tests on various thermoplastic cables at increasing voltages and faced failures of some insulating systems.

The Applicant surprisingly found that the electric performance at voltages greater than 150 kV of cables comprising at least one layer of the insulating system based on a polypropylene matrix intimately admixed with a dielectric fluid could be related to the amorphicity of the polypropylene matrix. Without wishing being bound to a theory, the Applicant observed that a polypropylene matrix having a prominent amorphous component favorably influences the electric behavior at high voltages of an insulating system comprising such matrix intimately admixed with a dielectric fluid.

Accordingly, the present invention relates to a power cable having an insulation system comprising at least one layer made of a thermoplastic material based on a polypropylene matrix admixed with a dielectric fluid, the thermoplastic material having a melting enthalpy of from 15 to 50 J/g and the polypropylene matrix being made of a material selected from:
a heterophasic ethylene-propylene copolymer (a) having a melting enthalpy of from 15 to 50 J/g; or
an intimate admixture of (a) and a propylene homopolymer or an ethylene propylene copolymer (b) having a melting enthalpy greater than 50 J/g.

The cable of the invention is particularly suitable for current transport at high voltage or extra high voltage.

In the present description and claims, as high voltage it is meant a voltage from 30 kV to 150 kV, while as extra high voltage it is meant a voltage greater than 150 kV.

The insulating system of the cable of the invention comprises an inner semiconducting layer, an insulating layer and an outer semiconducting layer. At least one of these layers is made of the thermoplastic material according to the invention, preferably the insulating layer. More preferably, all of the three layers of the insulating system are made of the thermoplastic material according to the invention.

In the present description and claims, as “melting enthalpy” it is meant the heat energy (expressed as J/g) required for melting (breaking down) the crystalline lattice. It is calculated by DSC (differential scanning calorimetry) by integrating the area defined by the melting peak and the baseline before and after the melting peak as disclosed, for example, in ISO 11357-1:1997. In the present description, as “amorphicity” it is meant the amount of amorphous elastomeric phase or region in a polymer with respect to crystalline content. The polymer amorphicity is determined with DSC by quantifying the heat associated with the polymer melting. This heat is reported as percent crystallinity by normalizing the observed heat of fusion to that of a 100% crystalline sample of the same polymer (http://www.tainstruments.co.jp/application/pdf/Thermal_Library/Applications_Briefs/TA123.PDF).

The amount of amorphous component can be expressed by the melting enthalpy of the thermoplastic material which is mainly determined by the melting enthalpy of the polypropylene (PP) matrix. A low melting enthalpy (i.e. less energy required to break down the crystalline lattice) indicates a higher amount of amorphous component, and vice versa.

As it will be shown in the following, an insulating system layer made of a thermoplastic material having a melting enthalpy greater than 50 J/g gives place to significant partial discharge phenomena when tested at a voltage greater than 150 kV and electric gradient of 10 kV/mm in alternate current (AC). On the other side, an insulating system layer made of a thermoplastic material with a melting enthalpy lower than 15 J/g has poor mechanical and thermo-mechanical properties.

Preferably, the thermoplastic material has a melting enthalpy of from 20 to 45 J/g.

In the present description and claims, with “heterophasic copolymer” it is meant a copolymer in which elastomeric domains are dispersed in a polymer matrix. Preferably the heterophasic copolymer of the invention has ethylene-propylene elastomer (EPR) as elastomeric domains dispersed in a propylene copolymer matrix.

Advantageously, the heterophasic ethylene-propylene copolymer (a) comprises an elastomeric phase in an amount of from 45 to 85 wt % with respect to the total weight of the copolymer.

Preferably, the heterophasic ethylene-propylene copolymer (a) has a melting enthalpy of from 20 to 45 J/g.

Preferably the propylene homopolymer or the ethylene propylene copolymer (b) has a melting enthalpy greater than 60 J/g.

The ethylene propylene copolymer (b) can be either heterophasic or random, the latter being preferred.

In the present description and claims, with “random copolymer” it is meant a copolymer in which the comonomers are randomly distributed along the polymer chain.

Preferably, the thermoplastic material has a melt flow rate of from 0.4 to 5 g/10 min at 2.16 kg/230° C., according to ISO 1133-99.

Preferably, the thermoplastic material has a flexural modulus of from 80 to 400 MPa measured according to ASTM D790-10.

Advantageously, the thermoplastic material has a melting peak greater than 140° C. In the case of EHV application, this melting peak is preferably greater than 150° C. The melting peak can be calculated as disclosed, for example, in ISO 11357-1:1997.

When the thermoplastic material of the cable of the invention is made by an intimate admixture of copolymer (a) and homopolymer or copolymer (b), the ratio between the two polymeric components is governed by their specific melting enthalpy and by the melting enthalpy of the thermoplastic material to be obtained.

Advantageously, the thermoplastic material of the cable of the invention comprises from 1 wt % to 10 wt % of dielectric fluid, preferably from 3 wt % to 7 wt %.

The dielectric fluid can influence the melting enthalpy of the thermoplastic material, but in minor extent. The addition of dielectric fluid in the above indicated amounts can increase the melting enthalpy of the thermoplastic material of from substantially 0 to 10 J/g.

Suitable dielectric fluids for use in the cable of the invention are described, e.g., in WO 02/03398, WO 02/27731, WO 04/066318, and WO 08/058572.

Advantageously, the dielectric fluid has a predetermined viscosity in order to prevent fast diffusion of the liquid within the insulating layer and hence its outward migration, as well as to enable the dielectric fluid to be easily fed and mixed into the thermoplastic polymer material. Generally, the dielectric fluid of the invention has a viscosity, at 40° C., of from 10 cSt to 800 cSt, preferably of from 20 cSt to 500 cSt (measured according to ASTM standard D445-03).

Examples of suitable dielectric fluids are: aromatic oils, either monocyclic, or polycyclic (condensed or not), wherein aromatic or moieties can be substituted by at least one alkyl group C₁-C₂₀, and mixtures thereof. When two or more cyclic moieties are present, such moieties may be linked by an alkenyl group C₁-C₅.

For example, the dielectric fluid comprises at least one alkylaryl hydrocarbon having the structural formula (I):

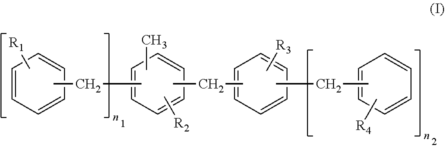

wherein:

R₁, R₂, R₃ and R₄, equal or different, are hydrogen or methyl;

n₁ and n₂, equal or different, are zero, 1 or 2, with the proviso that the sum n₁+n₂ is less than or equal to 3.

In another example, the dielectric fluid comprises at least one diphenyl ether having the following structural formula (II):

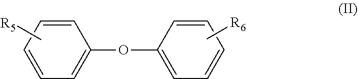

wherein R₅ and R₆ are equal or different and represent hydrogen, a phenyl group non-substituted or substituted by at least one alkyl group, or an alkyl group non-substituted or substituted by at least one phenyl. By alkyl group it is meant a linear or branched C₁-C₂₄, preferably C₁-C₂₀, hydrocarbon radical.

The dielectric fluid according to the invention can have a ratio of number of aromatic carbon atoms to total number of carbon atoms (hereinafter also referred to as Cₐᵣ/Cₜₒₜ) greater than or equal to 0.3. More preferably, Cₐᵣ/Cₜₒₜ is lower than 1. The number of aromatic carbon atoms is intended to be the number of carbon atoms which are part of an aromatic ring. The ratio of number of aromatic carbon atoms with respect to the total number of carbon atoms may be determined according to ASTM standard D3238-95(2000)e1.

For the purpose of the present description and of the appended claims, the words “a” or “an” are used to describe elements and components of the invention. This is done merely for convenience and to give a general sense of the invention. This description and claims should be read to include one or at least one and the singular also includes the plural unless it is obvious that it is meant otherwise.

For the purpose of the present description and of the appended claims, except where otherwise indicated, all numbers expressing amounts, quantities, percentages, and so forth, are to be understood as being modified in all instances by the term “about”. Moreover, all ranges include any combination of the maximum and minimum points disclosed and include any intermediate ranges therein, which may or may not be specifically enumerated herein.

### BRIEF DESCRIPTION OF THE DRAWING

Further characteristics will be apparent from the detailed description given hereinafter with reference to the accompanying drawing, in which:

FIG. 1 is a perspective view of an electric cable according to the invention.

### DETAILED DESCRIPTION OF THE PREFERRED EMBODIMENTS

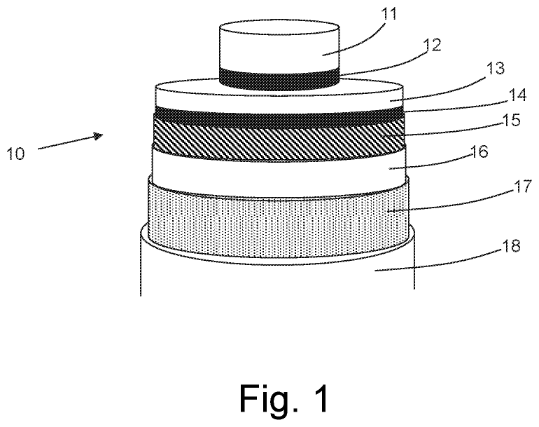

FIG. 1 shows a cable (10) according to the invention, suitable for transport high voltage or extra high voltage current. Cable (10) is a single core cable comprising a conductor (11) sequentially surrounded by an inner layer semiconducting layer (12), an insulating layer (13) and an outer semiconducting layer (14), these three layers constituting the insulating system.

The outer semiconducting layer (14) is surrounded by metal screen (15) which is surrounded, in turn, by a metal water barrier (17). Between the metal screen (15) and the metal water barrier (17), a semiconducting tape (16) is interposed having cushioning and, preferably, or water-absorbent properties.

An outer sheath (18) is the outermost layer.

The conductor (11) generally consists of metal wires, preferably of copper or aluminium, stranded together by conventional methods, or of a solid aluminium or copper rod. At least one of insulating layer (13) and inner and outer semiconductive layers (12) and (14) is made of a thermoplastic material according to the invention as heretofore defined.

The metal screen (15) is generally made of electrically conducting wires or tapes helically wound, while the metal water barrier (17) is generally made of aluminium or copper, preferably in form of a foil longitudinally wound around the metal screen (15).

The outer sheath (18) is generally made of thermoplastic polyethylene, for example high density polyethylene (HDPE) or medium density polyethylene (MDPE). Advantageously, le outer sheath (18) can be made of a material having low-smoke zero halogen properties.

FIG. 1 shows only one embodiment of a cable according to the invention. Suitable modifications can be made to this embodiment according to specific technical needs and application requirements without departing from the scope of the invention.

The layer or layers of thermoplastic material according to the present invention may be manufactured in accordance with known methods, for example by extrusion. The extrusion is advantageously carried out in a single pass, for example by the tandem method in which individual extruders are arranged in series, or by co-extrusion with a multiple extrusion head.

Three sample cables having the design of cable (10) of FIG. 1 were manufactured. The sample cables were 500 m long, had one conductor made of copper stranded wires and a conductor cross-section area of 1,000 mm². The screen was made of aluminium tape sandwiched by two water-swellable tapes. The whole was surrounded by an aluminium water barrier in form of foil longitudinally folded. The outer sheath of all of the sample cables was made of HDPE.

The three sample cables had the insulating layer made of a thermoplastic material as set forth in Table 1 and a thickness of about 17 mm. All of the three sample cables have the inner and the outer semiconductive layer made of a mixture HPP/RPP 70:30 containing dibenzyltoluene (6 wt %) and conductive carbon black (30 wt %).

TABLE 1

| | Thermoplastic material | | | |
|---|---|---|---|---|
| Sample | PP matrix | Dielectric fluid | Melting | Melting |
| Cables | (ratio) | (amount) | enthalpy | peak |
| S1 | HPP | Dibenzyltoluene | 24 J/g | 162° C. |
| | 100 | (6 wt %) | | |
| S2 | HPP/RPP | Dibenzyltoluene | 40 J/g | 159° C. |
| | 75/25 | (6 wt %) | | |
| S3* | HPP/RPP | Naphthenic oil | 56 J/g | 154° C. |
| | 50/50 | (6 wt %) | | |

*comparative
HPP: heterophasic ethylene-propylene copolymer having a melting enthalpy of 23 J/g and about 70 wt % of elastomeric phase;
RPP: random ethylene propylene copolymer having a melting enthalpy of 78 J/g;
Dibenzyltoluene: Cₐᵣ/Cₜₒₜ = 0.86
Naphthenic oil: 3 wt % aromatic carbon atoms, 41 wt % naphthenic carbon atoms, 56 wt % paraffinic carbon atoms and 0.1 wt % polar compounds; Cₐᵣ/Cₜₒₜ < 0.04.

The three sample cables were tested under alternate current (AC) at increasing voltage and electric gradient. In particular, sample cables S1 and S2 according to the invention successfully passed power frequency voltage tests up to 260 kV (21 kV/mm) showing partial discharge level lower than 2 pC at this voltage. Sample cables S1 and S2 had not breakdown when tested at 422 kV (34.2 kV/mm).

Comparative sample cable S3, under the same test conditions, showed an increasing partial discharge level (60 pC after 5 minutes at 130 kV and 10 kV/mm; 45 pC after 5 minutes at 200 kV and 16.2 kV/mm) then had a breakdown after 2 minutes at 260 kV (21 kV/mm).

Another sample cable S1 according to the invention was tested under direct current (DC). 50 m of sample was subjected to voltage of 500 kV (30 kV/mm), 550 kV (33 kV/mm) and 600 kV (36 kV/mm) for five cycles per each voltage. The conductor temperature was of 70-75° C. Neither breakdown nor flashover has occurred. No evidence of thermal instability or any other phenomenon which could lead to electrical or thermal degradation during a long term test.

Also another sample of comparative cable S3 was tested under DC. 60 m of sample was subjected to voltages at the same conditions disclosed above. The conductor temperature was of 70-75° C. During ramping (100_kV/10 min) from 500 kV to 550 kV (at approximately 530 kV) the tested sample broke down.

Morphological investigations by SEM microscopy were carried out on the insulating layer of the sample cable S3. The results indicate lack of cohesion between the matrix components in the polypropylene matrix (and not in the dielectric fluid) observed. In particular, the lack of cohesion regarded the elastomeric amorphous phase (mainly provided by the heterophase copolymer (a)) and the crystalline phase (mainly provided by the random copolymer (b)), and resulted in microcavities and microcracks.

Analogous SEM microscopy inspections were carried out on the insulation material of sample cable S1 according to the invention and substantially no microfractures between the amorphous and the crystalline phase of the insulation were detected.

Cables having at least one layer of the insulation system made of a thermoplastic material according to the invention showed to efficiently perform at extra high voltages.

1. Power cable having an insulation system comprising at least one layer made of a thermoplastic material based on a polypropylene matrix admixed with a dielectric fluid, the thermoplastic material having a melting enthalpy of from 15 to 50 J/g and the polypropylene matrix being made of a propylene material selected from:
a heterophasic ethylene-propylene copolymer (a) having a melting enthalpy of from 15 to 50 J/g; or
an intimate admixture of (a) and a propylene homopolymer or an ethylene propylene copolymer (b) having a melting enthalpy greater than 50 J/g.

2. Power cable according to claim 1 suitable for current transport at high voltage or extra high voltage.

3. Power cable according to claim 1 wherein the insulating system comprises an inner semiconducting layer, an insulating layer and an outer semiconducting layer, and at least the insulating layer is made of the thermoplastic material as described in claim 1.

4. Power cable according to claim 2 wherein the inner semiconducting layer and an outer semiconducting layer are made of the thermoplastic material as described in claim 1.

5. Power cable according to claim 1 wherein the thermoplastic material has a melting enthalpy of from 20 to 45 J/g.

6. Power cable according to claim 1 wherein the heterophasic ethylene-propylene copolymer (a) comprises an elastomeric phase in an amount of from 45 to 85 wt % with respect to the total weight of the copolymer.

7. Power cable according to claim 1 wherein the heterophasic ethylene-propylene copolymer (a) has a melting enthalpy of from 20 to 45 J/g.

8. Power cable according to claim 1 wherein the propylene homopolymer or the random ethylene propylene copolymer (b) has a melting enthalpy greater than 60 J/g.

9. Power cable according to claim 1 wherein (b) is a random ethylene propylene copolymer.

10. Power cable according to claim 1 wherein the thermoplastic material comprises from 1 wt % to 10 wt % of dielectric fluid.

11. Power cable according to claim 9 wherein the thermoplastic material comprises from 3 wt % to 7 wt % of dielectric fluid.

12. Power cable according to claim 1 wherein the thermoplastic material has a melt flow rate of from 0.4 to 5 g/10 min at 2.16 kg/230° C.

13. Power cable according to claim 1 wherein the thermoplastic material has a flexural modulus of from 80 to 400 MPa.

14. Power cable according to claim 1 wherein the thermoplastic material has a melting peak greater than 140° C.

15. Power cable according to claim 14 wherein the thermoplastic material has a melting peak greater than 150° C.
